(19) United States
(12) Patent Application Publication
(10) Pub. No.: US 2024/0391794 A1
(43) Pub. Date: Nov. 28, 2024

(54) Geopolymer Compositions and Systems and Methods Thereof for Sequestering and Removing Chemical Species From Water

(71) Applicant: The Board of Trustees of the University of Illinois, Urbana, IL (US)

(72) Inventors: Waltraud M. Kriven, Urbana, IL (US); Ali Ozer, Urbana, IL (US); Abdul Qadeer, Urbana, IL (US)

(73) Assignee: The Board of Trustees of the University of Illinois, Urbana, IL (US)

(21) Appl. No.: 18/672,558

(22) Filed: May 23, 2024

Related U.S. Application Data
(60) Provisional application No. 63/504,222, filed on May 25, 2023.

(51) Int. Cl. C02F 1/00; C02F 1/58; C02F 1/62; C02F 101/20; C02F 101/36

(52) U.S. Cl. CPC C02F 1/001; C02F 1/583; C02F 1/62; C02F 2101/20; C02F 2101/36

(57) ABSTRACT

Water-filtering compositions including a geopolymer and a sequestration agent are provided herein. Filters including the compositions are further provided. Water filtration systems including the filters are further provided. Processes for the preparation of the compositions are further provided. Methods of reducing an amount of a chemical species from a body of water are further provided. Chemical species that are reduced include neutral or ionic heavy metal species or polyfluorinated chemical species.

### CROSS-REFERENCE TO RELATED APPLICATIONS

The present application claims the benefit of U.S. Provisional Application No. 63/504,222, filed May 25, 2023, the entirety of which is incorporated by reference herein for all purposes.

### TECHNICAL FIELD

The present disclosure relates to compositions, apparatuses, and methods for water filtration.

### BACKGROUND

The sequestering of water pollutants to provide better water quality to billions of people globally has been a continuous global challenge. Arsenic species are among the most dangerous heavy metal species, causing cancer and other health problems for hundreds of millions of people. Adsorption systems for treating arsenic in water sources typically employ metal (hydr)oxides such as iron (hydr)oxide, titanium dioxide, hematite, and goethite. However, many conventional adsorption materials demonstrate low adsorption capacity, are unstable at low or high pH values, have a high production cost, and are difficult to regenerate.

There is a need for compositions that can sequester water pollutants such as heavy metals from sources of water. Further, there is a need for filters including the compositions and methods of using the filters to clean water sources.

### SUMMARY

In an example, the present disclosure provides a water-filtering composition, including: a geopolymer; a foaming agent; and a sequestration agent.

In another example, the present disclosure provides a process for preparing a water-filtering composition, including: mixing metakaolin and waterglass to produce a mixture; adding an amount of the foaming agent to the mixture to produce a porous mixture; and adding the sequestration agent to the porous mixture to produce the composition.

In yet another example, the present disclosure provides a method of reducing an amount of a chemical species in a body of water, including: adding to the body of water a filter including a composition, the composition including a geopolymer, a foaming agent, and a sequestration agent.

In yet another example, the present disclosure provides geopolymers to which a silicon species has been added to be included as a non-burnable, insulating material for the construction of physical structures, such as dwellings or other buildings.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the present disclosure may be well understood, there will now be described various forms thereof, given by way of example, reference being made to the accompanying drawings. The components in the figures are not necessarily to scale.

FIG. 1 illustrates an analysis of particle size of metakaolin used as a reagent to prepare examples of compositions of the present disclosure;

FIGS. 2(a), 2(b), 2(c), and 2(d) illustrate scanning electron microscopy (SEM) images of aluminum powder, nano-silicon powder, 45 μm ground/sieved silicon powder, and 145 μm silicon powder, respectively;

FIGS. 3(a), 3(b), 3(c), and 3(d) illustrate particle size distributions for nano-silicon powder, 45 μm ground/sieved silicon powder, aluminum powder, and 145 μm silicon powder, respectively;

FIGS. 4(a) and 4(b) illustrate SEM images of geopolymer including 1 weight % silicon powder of 145 μm particle size and 5 weight % silicon powder of 145 μm particle size, respectively.

FIG. 5 illustrates an example of geopolymer chains;

FIG. 6 illustrates x-ray diffraction patterns of examples of geopolymers including 1 weight % and 5 weight % silicon powder of 145 μm particle size;

FIGS. 7(a), 7(b), and 7(c) illustrate SEM images of examples of geopolymers including 1 weight % of nano-silicon powder, silicon powder of 14.4 μm particle size, and silicon powder of 145 μm particle size, respectively;

FIG. 8(a) illustrates a SEM image of an example of a geopolymer including 1 weight % silicon, 1 weight % graphene oxide, and 1 weight % hydrogen peroxide with 11 moles of water, cured at 70° C., and FIG. 8(b) is an exploded view of the area inside the black square in FIG. 8(a);

FIG. 9(a) illustrates a SEM image of an example of a geopolymer including 1 weight % silicon, 1 weight % graphene oxide, and 1 weight % silicon powder with 15 moles of water, cured at 70° C., and FIG. 9(b) is an exploded view of the area inside the black square in FIG. 9(a);

FIG. 10 illustrates X-ray diffraction patterns of the geopolymers illustrated in FIGS. 8(a), 8(b), 9(a), and 9(b);

FIG. 11 illustrates a chart of X-ray fluorescence (“XRF”) analysis of different arsenic contents vs. counts per second, and actual measurement responses for geopolymers with different graphene oxide weight % values;

FIG. 12 illustrates XRF results of elemental weight % ratios by geopolymers with different graphene oxide weight % values in filtered solutions after arsenic removal;

FIG. 13 illustrates an exploded view of the 0 to 50 parts per billion (ppb) range of FIG. 11 by geopolymers with different graphene oxide weight % values; and

FIGS. 14A, 14B, and 14C illustrate SEM images of graphene oxide flakes decorating the walls of the pores of the geopolymer composition, at respective horizontal field widths (“HFWs”) of 414 μm, 41.4 μm, and 20.7 μm.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

The uses of the terms “a” and “an” and “the” and similar referents in the context of describing the present disclosure (especially in the context of the following claims) are to be construed to cover both the singular and the plural, unless otherwise indicated herein or clearly contradicted by context. The use of the term “plurality of” is defined by the Applicant in the broadest sense, superseding any other implied definitions or limitations hereinbefore or hereinafter unless expressly asserted by Applicant to the contrary, to mean a quantity of more than one. All methods described herein may be performed in any suitable order unless otherwise indicated herein by context.

As will be understood by one skilled in the art, for any and all purposes, all ranges recited herein also encompass any and all possible sub-ranges and combinations of sub-ranges thereof, as well as the individual values making up the range, particularly integer values. It is therefore understood that each unit between two particular units is also disclosed. For example, if “10 to 15” is disclosed, then 11, 12, 13, and 14 are also disclosed, individually, and as part of a range. A recited range (for example, weight percentages or carbon groups) includes each specific value, integer, decimal, or identity within the range. Any listed range may be easily recognized as sufficiently describing and enabling the same range being broken down into at least equal halves, thirds, quarters, fifths, or tenths. As will be understood by one skilled in the art, all language such as “up to,” “at least,” “greater than,” “less than,” “more than,” “or more,” and the like, include the number recited and such terms refer to ranges that may be subsequently broken down into sub-ranges. In the same manner, all ratios recited herein also include all sub-ratios falling within the broader ratio. Accordingly, specific values recited for radicals, substituents, and ranges are for illustration only; the specific values do not exclude other defined values or other values within defined ranges for radicals and substituents. It will be further understood that the endpoints of each of the ranges are significant both in relation to the other endpoint, and independently of the other endpoint.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or examples whereby any one or more of the recited elements, species, or examples may be excluded from such categories or examples, for example, for use in an explicit negative limitation.

As used herein, the terms “comprise(s),” “include(s),” “having,” “has,” “may,” contain(s),” and variants thereof, are intended to be open-ended transitional phrases, terms, or words that do not preclude the possibility of additional acts or structures. The present description also contemplates other examples “comprising,” “consisting of,” and “consisting essentially of” the examples or elements presented herein, whether explicitly set forth or not.

In describing elements of the present disclosure, the terms “1^{st},” “2^{nd},” “first,” “second,” “A,” “B,” “(a),” “(b),” and the like may be used herein. These terms are only used to distinguish one element from another element, but do not limit the corresponding elements irrespective of the nature or order of the corresponding elements.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art.

As used herein, the term “about,” when used in the context of a numerical value or range set forth means a variation of ±15%, or less, of the numerical value. For example, a value differing by ±15%, ±14%, ±10%, or ±5%, among others, would satisfy the definition of “about,” unless more narrowly defined in particular instances.

As used herein, the term “fluorine-containing” means organic chemical compounds or moiety that (1) is “fluorinated,” or contains carbon-hydrogen bonds and a carbon-fluorine bond; (2) is “polyfluorinated,” or contains carbon-hydrogen bonds and more than one carbon-fluorine bond; or (3) is “perfluorinated,” in which case carbon is bonded to no hydrogen atoms and, instead of any hydrogen atoms, only fluorine atoms. Some fluorinated compounds are polyfluorinated, and some polyfluorinated compounds are perfluorinated.

Examples of geopolymers may include repeating amorphous chemical networks including: repeating Si—O—Al—O— bond units, wherein the Si atoms are the central atoms of SiO₄ tetrahedra and the Al atoms are the central atoms of AlO₄⁻ tetrahedra; and one or more Group I element cations. A particular example of a geopolymer is illustrated in FIG. 5. See V. F. F. Barbosa, et al., Synthesis and Characterisation of Materials Based on Inorganic Polymers of Alumina and Silica: Sodium Polysialate Polymers, 2 INT. J. INORGANIC MATERIALS 309 (2000), which is incorporated herein by reference in its entirety.

Herein is described a composition including a geopolymer and a sequestration agent. By adding a sequestration agent to a geopolymer to form a porous geopolymer mixture, a water-filtering composition may be formed. The porous geopolymers of the present disclosure may contain large pores, and smaller pores within the walls of the large pores, as well as sequestration agents within the pores. A sequestration agent such as graphene oxide within a pore may resemble a “flake.” The sequestration agent may sequester chemical species such as heavy metal species from aqueous solution by the action of functional groups on the sequestration agent such as hydroxyl (“—OH”) or carboxylic acid (“—CO₂H”).

Porous geopolymer compositions of the present disclosure may be used to remove pollutant chemical species from solutions, including chemical species such as heavy metals. Examples of chemical species that may be removed by the porous geopolymer compositions of the present disclosure may include arsenic, lead, zinc, nickel, copper, mercury, and combinations thereof. The geopolymer may be easy to use as a bulk or sheet material in a tube or reactor as a continuous filter, or as a powder in a batch reactor. The compositions may also be scaled up to blocks or columns to filter vast amounts of water in reasonable amounts of time. The present disclosure demonstrates the filtration and sequestration of arsenic from solutions containing 500 μg/L (equivalent to parts per billion, “ppb”) resulting in filtered solution containing only 16 ppb arsenic. The sequestration agent and foaming agent may act synergistically to result in better sequestration of chemical species relative to a composition that does not contain a sequestration agent and/or foaming agent. The sequestration agent may remain inside the pores of the geopolymer with the filtered chemical species attached on the sequestration agent, and the sequestration agent may be regenerated for further sequestration activity while storing the filtered chemical species separately. The performance of geopolymer composition may be measured after a sequence of filtration or sequestration, such as after at least 10, or at least 20, or at least 50 filtrations to determine whether the graphene oxide was removed from the geopolymer composition. The arsenic may be stored in concentrated weight % in acidic (such as nitric acid or hydrochloric acid), alcoholic (ethanol or methanol), or basic (sodium hydroxide or potassium hydroxide) solutions. Geopolymers may be acid resistant. Graphene oxide may be centrifugally sedimented and regenerated to form new graphene oxide for preparing more porous geopolymer compositions.

In an example, the present disclosure provides a water-filtering composition, including a geopolymer and a sequestration agent. In certain examples, the sequestration agent may include graphene nano-ribbon, graphene oxide, reduced graphene oxide, iron oxide, titanium oxide, or combinations thereof. In other examples, the sequestration agent may be present in an amount of from about 0.5 weight % to about 5.0 weight % based on a combined 100 weight % total of the composition. In still other examples, the composition may include a foaming agent. In still other examples, the foaming agent may be silicon and/or hydrogen peroxide.

In still other examples, the geopolymer may include pores having an average pore size of more than about 500 μm, including, for example, greater than about 505 μm, or greater than about 510 μm, or greater than about 515 μm, or greater than about 520 μm, or greater than about 525 μm, or greater than about 530 μm, or greater than about 535 μm, or greater than about 540 μm, or greater than about 545 μm, or greater than about 550 μm, or greater than about 555 μm, or greater than about 560 μm, or greater than about 565 μm, or greater than about 570 μm, or greater than about 575 μm, or greater than about 580 μm, or greater than about 585 μm, or greater than about 590 μm, or greater than about 595 μm, or greater than about 600 μm, or greater than about 605 am, or greater than about 610 μm, or greater than about 615 μm, or greater than about 620 μm, or greater than about 625 μm, or greater than about 630 μm, or greater than about 635 μm, or greater than about 640 μm, or greater than about 645 μm, or greater than about 650 μm, or greater than about 655 μm, or greater than about 660 μm, or greater than about 665 μm, or greater than about 670 μm, or greater than about 675 μm, or greater than about 680 μm, or greater than about 685 μm, or greater than about 690 μm, or greater than about 695 μm, or greater than about 700 μm; or a range formed from any two of the foregoing average pore sizes; including any subranges therebetween.

In still other examples, the geopolymer may include pores having an average pore size of less than about 50 μm, including, for example, less than about 45 μm, or less than about 40 μm, or less than about 35 μm, or less than about 30 μm, or less than about 25 μm, or less than about 20 μm, or less than about 15 μm, or less than about 10 μm, or less than about 5 μm; or a range formed from any two of the foregoing average pore sizes, including any subranges therebetween.

In still other examples, the geopolymer may include pores having an average pore size of greater than about 500 μm and pores having an average pore size of less than about 50 μm.

In still other examples, the sequestration agent may be present in an amount relative to a combined 100 weight % total of the composition of about 0.5 weight %, or about 0.6 weight %, or about 0.7 weight %, or about 0.8 weight %, or about 0.9 weight %, or about 1.0 weight %, or about 1.1 weight %, or about 1.2 weight %, or about 1.3 weight %, or about 1.4 weight %, or about 1.5 weight %, or about 1.6 weight %, or about 1.7 weight %, or about 1.8 weight %, or about 1.9 weight %, or about 2.0 weight %, or about 2.1 weight %, or about 2.2 weight %, or about 2.3 weight %, or about 2.4 weight %, or about 2.5 weight %, or about 2.6 weight %, or about 2.7 weight %, or about 2.8 weight %, or about 2.9 weight %, or about 3.0 weight %, or about 3.1 weight %, or about 3.2 weight %, or about 3.3 weight %, or about 3.4 weight %, or about 3.5 weight %, or about 3.6 weight %, or about 3.7 weight %, or about 3.8 weight %, or about 3.9 weight %, or about 4.0 weight %, or about 4.1 weight %, or about 4.2 weight %, or about 4.3 weight %, or about 4.4 weight %, or about 4.5 weight %, or about 4.6 weight %, or about 4.7 weight %, or about 4.8 weight %, or about 4.9 weight %, or about 5.0 weight %; or a range formed from any two of the foregoing percentages; including any subranges therebetween.

In an example, the present disclosure provides a filter including an example of a composition of the present disclosure. In certain examples, the filter is disposed in a water source. In other examples, the water source may be natural, anthropogenic, or an industrial effluent.

In an example, the present disclosure provides a chemical reactor including an example of a filter or an example of a composition of the present disclosure.

In an example, the present disclosure provides a water filtration system including an example of a filter of the present disclosure submerged within a body of water. In certain examples, the filter may be disposed in the body of water to decrease an amount of a chemical species in the body of water.

Examples of the chemical species may include a neutral or ionic heavy metal species, such as, for example, arsenic, lead, zinc, nickel, copper, mercury, or combinations thereof.

In an example, the present disclosure provides a process for preparing an example of a composition of the present disclosure, including: mixing metakaolin and waterglass to produce a mixture; adding an amount of silicon powder to the mixture to produce a porous, foamed mixture; and adding the sequestration agent to the porous mixture to produce the composition. In certain examples, the process further includes adding a foaming agent to the composition. Examples of foaming agents may include silicon and hydrogen peroxide.

In other examples, the process further includes heating the composition in at least 50% relative humidity, including, for example, at least 55% relative humidity, at least 60% relative humidity, at least 65% relative humidity, at least 70% relative humidity, at least 75% relative humidity, at least 80% relative humidity, at least 85% relative humidity, at least 90% relative humidity, at least 95% relative humidity, or at least 99% relative humidity; including a range formed from any two of the foregoing relative humidities; including any subranges therebetween.

In certain examples, the heating may be for at least 24 hours. In other examples, the heating may be at 90% relative humidity.

In certain examples, the heating may be at a temperature of from about 40° C. to about 60° C., including, for example, about 45° C., or about 50° C., or about 55° C.; or a range formed from any two of the foregoing temperatures; including any subranges therebetween.

In certain examples, an amount of silicon powder may be from about 0.5 weight % to about 4.0 weight % based on 100% total weight of the composition, including, for example, about 0.6 weight %, or about 0.7 weight %, or about 0.8 weight %, or about 0.9 weight %, or about 1.0 weight %, or about 1.1 weight %, or about 1.2 weight %, or about 1.3 weight %, or about 1.4 weight %, or about 1.5 weight %, or about 1.6 weight %, or about 1.7 weight %, or about 1.8 weight %, or about 1.9 weight %, or about 2.0 weight %, or about 2.1 weight %, or about 2.2 weight %, or about 2.3 weight %, or about 2.4 weight %, or about 2.5 weight %, or about 2.6 weight %, or about 2.7 weight %, or about 2.8 weight %, or about 2.9 weight %, or about 3.0 weight %, or about 3.1 weight %, or about 3.2 weight %, or about 3.3 weight %, or about 3.4 weight %, or about 3.5 weight %, or about 3.6 weight %, or about 3.7 weight %, or about 3.8 weight %, or about 3.9 weight %; or a range formed from any two of the foregoing percentages; including any subranges therebetween.

In an example, the present disclosure provides a method of reducing an amount of a chemical species in a body of water, including: adding to the body of water an example of a filter including an example of a composition, the composition including an example of a foamed geopolymer and an example of a sequestration agent. In certain examples, the amount of the chemical species may be reduced to less than 20 parts per billion (“ppb”). In other examples, the chemical species may include a neutral or ionic heavy metal species. In still other examples, the heavy metal species may include arsenic, lead, zinc, nickel, copper, mercury, or combinations thereof. In still other examples, the amount of the chemical species may be reduced by the filter relative to a filter not including an example of a sequestration agent and/or without an example of a foaming agent.

Examples of geopolymers of the present disclosure to which a silicon species has been added may be useful as insulating material for the construction of physical structures, such as dwellings or other buildings. A wall of a physical structure may include an inner geopolymer composite wall and an outer geopolymer composite wall. After the inner geopolymer composite wall and the outer geopolymer composite wall are set, a space in between the inner geopolymer composite wall and the outer geopolymer composite wall may be filled in with geopolymer including pore-forming silicon and sealed at the top of the inner geopolymer composite wall and the outer geopolymer composite wall, allowing the geopolymer-silicon formulation to froth up and become porous. Porous geopolymer thermal insulation may also be placed between cement and concrete walls as well. The porous geopolymer may be strengthened, for example, by mixing with particulates such as sand or chamotte, chopped basalt fibers, or alumina platelets, or by pouring over basalt fiber insulation. After setting under typical geopolymer-setting conditions, the porous geopolymer may be expected to behave as a non-burnable, thermal insulation material alternative to current organic chemical based (for example, polystyrene-based) insulations.

The compositions and methods described above may be better understood in connection with the following Examples. In addition, the following non-limiting examples are an illustration. The illustrated methods are applicable to other examples of compositions. The procedures described as general methods describe what is believed will be typically effective to prepare the compositions indicated. However, the person skilled in the art will appreciate that it may be necessary to vary the procedures for any given example of the present disclosure, for example, vary the order or steps and/or the chemical reagents used.

### EXAMPLES

### I. Materials.

Sodium hydroxide pellets were reagent grade, 99% purity purchased from Ward's Science (New York, USA). Silicon metal powder, 99.9% purity, was purchased from Alfa Aesar Johnson Matthey Company (Massachusetts, USA). Silicon nanopowder, 30-50 nanometer average particle size, 98% purity, was purchased from Nanostructured and Amorphous Material, Inc. (Houston, Texas, USA). Metakaolin (Metamax EF) with an average particle size of 2.66 μm was purchased form BASF GmbH (Germany).

### II. Preparation of Sodium Silicate Solution (“Waterglass”) and Characterization of Materials

Deionized water was added to a beaker on a magnetic plate and sodium hydroxide was slowly added to the water and stirred until completely dissolved. The solution was covered with polyethylene terephthalate plastic film, and the beaker was submerged in an ice bath to avoid heat produced by exothermic reaction of the alkaline solution. After complete dissolution and cooling down of the sodium hydroxide solution, an appropriate amount of silica fume was added into the solution over 2-3 hours with stirring, and stirring was continued for about 12 hours. The solution was weighed again after stirring was complete to check for water evaporation, and any volume of evaporated water was replenished. The solution was kept in a closed-lid polyethylene bottle at 4° C. to avoid water evaporation.

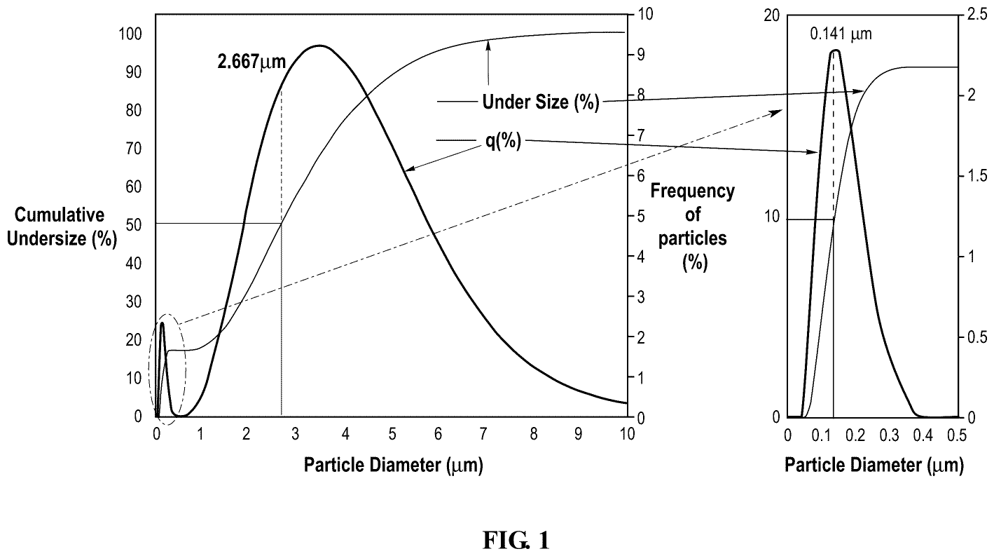

A laser particle size analyzer (PARTICA, HORIBA Scientific LA-950V2, Kyoto, Japan) was used to analyze the particle size distribution of metakaolin. FIG. 1 illustrates that the average particle size of metakaolin was about 2.66 μm for D₅₀. Some very fine particles had a size of 0.141 μm for D₁₀, which had relatively higher volume than larger particles, thereby generating a smaller D₅₀ that may not coincide with the peak of q %.

The powdered materials were analyzed in a scanning electron microscope (“SEM,” Axia ChemiSEM, Thermo Fisher, USA) for powder morphology of the purchased and ground powders.

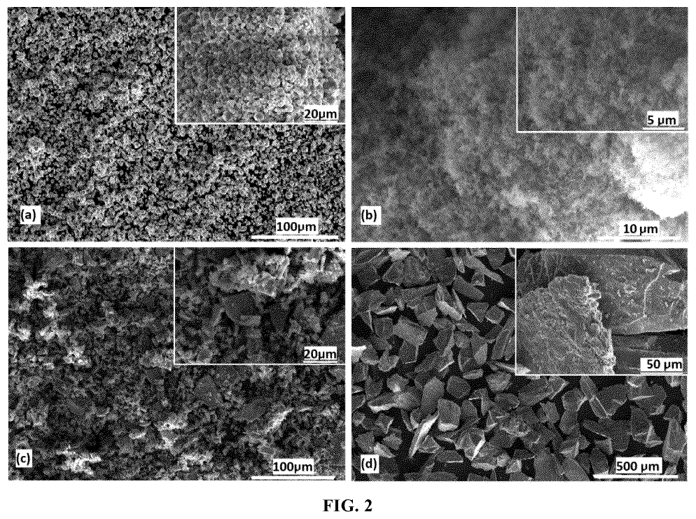

The powders were used without further treatment after grinding. Metallic aluminum with an average particle size of 5 μm and three silicon powders with different particle sizes of 150 μm, 15 μm, and 660 nm were used to analyze the effect of Si particle size as a pore forming agent. The average particle size graphs of metal powders are illustrated in FIG. 2. As illustrated in FIG. 2, aluminum powders are spherical, with an average particle size of 4 μm, as the aluminum powders were produced by gas atomization. Silicon metal powders were purchased with 145 μm and 100 nm average particle sizes, and 15 μm silicon powders were produced from 150 μm powders by planetary ball milling in a milling device (Fritsch GmbH, Pulverisette 6, Idar-Oberstein, Germany) in a 80 mL jar with a ball to powder ratio of 20, with 3 mm ZrO₂ grinder balls at 450 rpm for 5 minutes. Silicon powders may have irregular sharp edges as purchased, such as illustrated in FIG. 2(d), and were ground into finer particles, as illustrated in FIG. 2(c), which included sharp edges and rectangular cleavage fractures with an average particle size of 14.4 μm. Nanosilicon metal powders may have soft agglomerates after dispersion in water and distribution as finer powders. However, the nanosilicon metal powders may be separated by means of alkaline solution and shear mixing when added into the solution, and the surface area may be more than 20 m²/g compared to other powders that have surface areas of about 0.8 m²/g due to larger particle size.

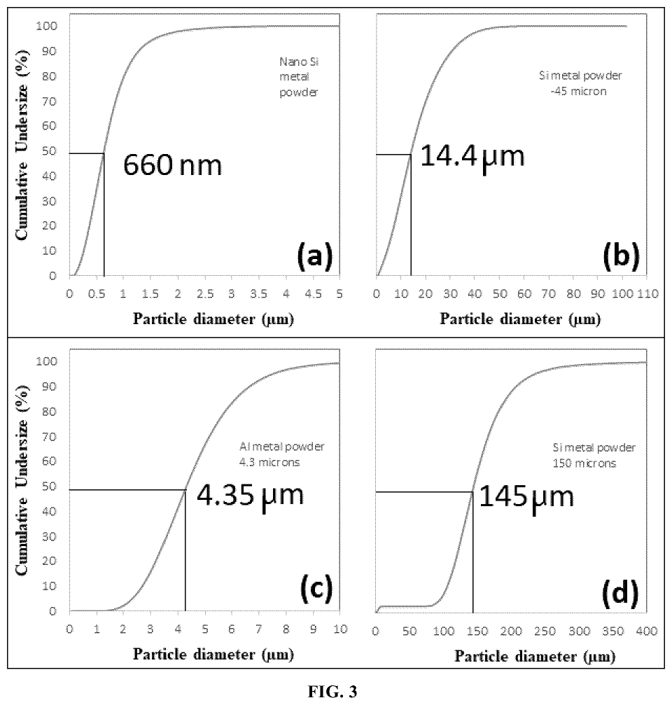

The average particle sizes of all metal powders as measured by a particle sizer were illustrated in FIGS. 3(a), 3(b), 3(c), and 3(d). The particle sizes were sorted from 75 nm (D₁₀) to 660 nm (D₅₀) for the finest nano Si metal powder as illustrated in FIG. 3(a). FIG. 3(b) illustrates a D₅₀ of 14.4 μm for Si metal powder ground and sieved under 45 μm. FIG. 3(c) illustrates a D₅₀ of 4.4 μm for aluminum metal powder. FIG. 3(d) illustrates a D₅₀ of 145 μm for Si metal powder. As illustrated from FIG. 3(a), nano-Si metal powders may be distributed in water until having particle sizes of 75 nm, as the nano-Si metal powders produce soft agglomerates of 500 nm or larger due to increased humidity and surface energy.

### III. Preparation of Geopolymer Compositions and Addition of Si Metal Powder.

Sodium silicate was weighed and poured into a polyethylene container, and mechanical mixing (IKA Eurostar Digital Mixer, Cole-Parmer, Illinois, USA) was begun at 400 rpm at high torque, while adding metakaolin powders slowly. After 1 minute of mechanical mixing, the shear mixing was initiated at 2000 rpm to produce a vortex and mix the powders with water to become a slurry. After 8 minutes of additional shear mixing, the metal powder with the desired particle size and in the desired weight % was added, and the composition was mixed for another minute, for a total of 10 minutes of mixing.

In initial experiments, coarser-size particles of Si of 145 μm were used, to see the effect of lower surface area powders. Slurries of 20 mL were cast in plastic cylindrical open molds with diameters of 30 millimeters. The molds were wrapped with polymer lids and heated at 50° C. for 24 hours in an electric oven (Carbolite Furnace, USA) at 90% relative humidity. As expected, the formation of pores and expansion in mold was vertical as water evaporated and condensed on the upper walls of the mold.

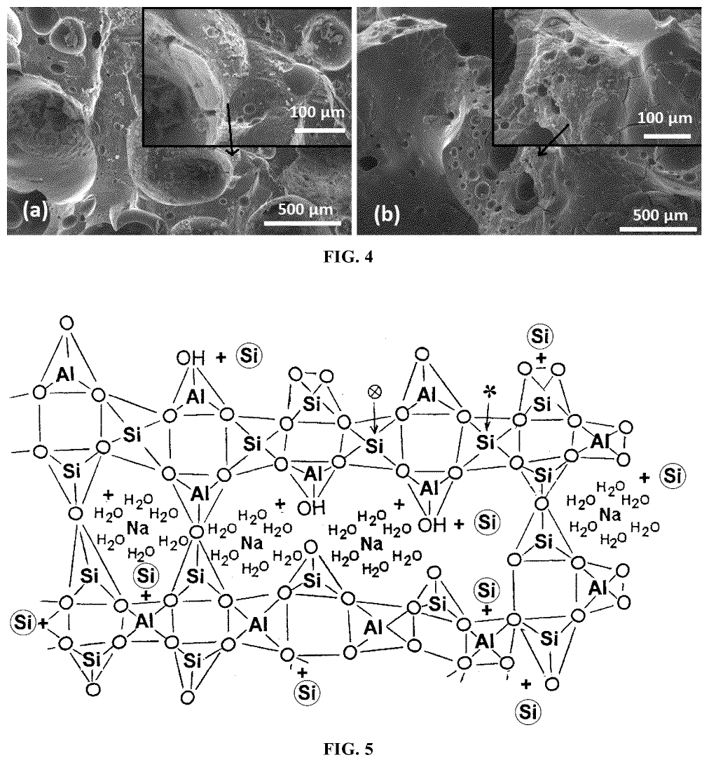

FIG. 4(a) illustrates a SEM image of geopolymer to which 1 weight % Si powder with 150 μm average particle size has been added. FIG. 4(b) illustrates a SEM image of geopolymer to which 5 weight % Si powder was added. The samples were cured at 50° C. at 90% relative humidity for 24 hours before microscopy. FIG. 4(a) illustrates an average pore size of about 600 μm. It was observed that the open-air network of pores increased by the elliptical shape of pores and with the thinner wall formation. The walls provide the structural skeleton, with pores inside the walls. By increasing the amount of metallic silicon to 5 weight %, the formation of pores was more favorable, with more silicon addition. By increasing the amount of metallic silicon to 5 weight %, pores of higher volume were formed as a result of the liberation of a larger amount of H₂ gas according to equation (1):

Si+4H₂O [symbol] Si(OH)₄+2H₂↑ (1)

Increasing silicon weight % would also produce more volumetric pores by the amount of silicon to react with the matrix. The H₂ gas formed according to equation (1) coarsened the pores in the matrix and reached outside as bigger pores. Si(OH)₄ is also a very reactive compound in alkaline media, forming SiO₂ according to equation (2):

Si(OH)₄ [symbol] SiO₂+2H₂O (2)

As the SiO₂ was produced around the parent Si powder and the Si powder was consumed, SiO₂ joined the geopolymer chain reaction to produce amorphous phase during the maturation period in the initial 24 hours heating in the oven. The water remained in the structure in the alkaline media so as to drive geopolymerization further. The wrapped mold of geopolymer during the initial 24 hours of curing kept the geopolymer composition at over 80% relative humidity, and as the reactions according to equations (1) and (2) occurred, the relative humidity may be kept constant inside the mold to favor the formation of amorphous geopolymer matrix that quickly hardens. By adding 5 weight % Si powder, the fine pores inside walls of bigger pores visibly connected with other fine pores more easily and more effectively. Si powder was dissolved and consumed by reacting with water and hydroxyl groups, and the geopolymerization reaction was a topochemical reaction that continued in the presence of silicon powder and water molecules until total silicon consumption.

As illustrated in FIG. 5, the silicon consumption may take place by addition of the silicon powder into the geopolymer matrix. The silicon may not add the center of the geopolymer chain when added at 1 weight %, such that only the outer water molecules react with Si metal to form the geopolymerization reactants. Addition of a low amount of silicon may break the bridging bonds formed by hydroxyl groups and water molecules that release hydrogen gas to form pores. When silicon was added at 5 weight %, excess silicon reacted with surrounding oxygen, hydroxyl groups, and water molecules inside the chain, and gave rise to the formation of more H₂ gas and breaking of more pores. As the bonds were broken, extra water molecules formed according to equation (2), promoting and carrying out the geopolymerization reaction.

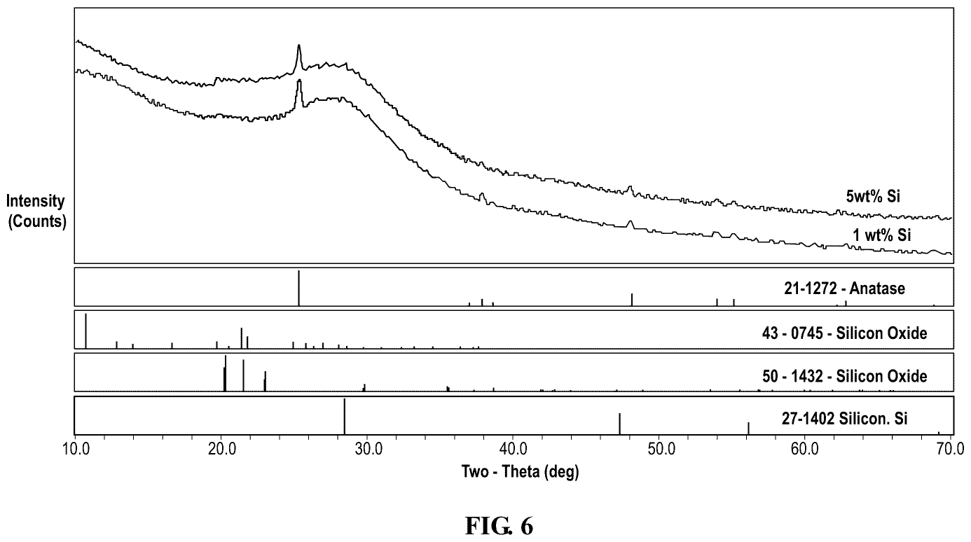

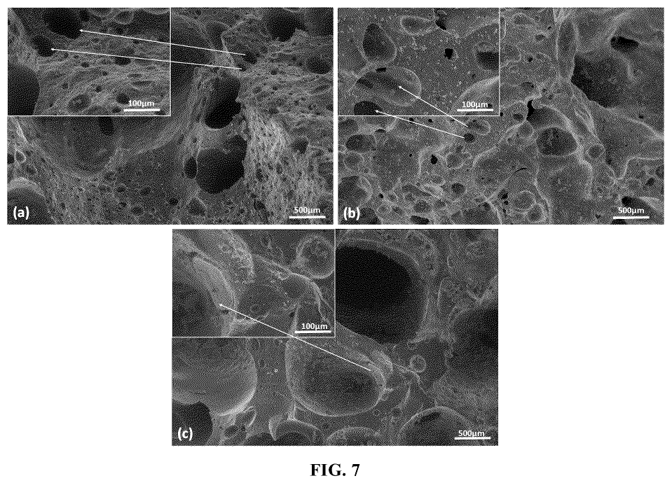

The X-ray diffraction (“XRD”) patterns of the 1 weight % and 5 weight % silicon samples were measured with an X-ray diffractometer (BRUKER D8-ADVANCE, Germany) equipped with a θ-2θ Bragg-Brentano geometry detector and tube. The samples were fabricated by adding 1 weight % and 5 weight % silicon into geopolymer and cured at 50° C. for 24 hours in 90% relative humidity and left for outside 3 days, before XRD was carried out, as illustrated by FIG. 6. FIG. 6 illustrates that both 1 weight % and 5 weight % silicon addition drove the formation of the geopolymer matrix, as demonstrated by two characteristic humps at about 15° and 28° (2θ) angles. The peaks reflecting the TiO₂ of metakaolin as crystalline impurity are visible at 25.1°, 46°, and 54° (2θ) angles. By the increase of the silicon amount in the geopolymer matrix, no change is visible by the formation of amorphous phase, demonstrating that all silicon powder added was consumed to produce amorphous SiO₂ to join the geopolymerization chain reaction. Only a very small amount of silicon remained unreacted in the geopolymer matrix.

The silicon dopant particle size dependency of fabricated geopolymers and pore formation were illustrated in FIGS. 7(a), 7(b), and 7(c). As illustrated in FIG. 7(a), 1 weight % nano-silicon addition to geopolymer composition resulted in the highest pore volume with the thinnest walls. Especially during the shear mixing of the geopolymer composition, by addition of nano-silicon powder, the geopolymer composition yielded a very sudden reaction, ending up a fluffy paste that could not be shear-mixed further. As a result, the pores seamed coarser and indistinguishable from each other by certain shapes, open to air as large “reservoir” pores such that water would pass through and drain from thinner pores that were also interconnected to other coarse/fine pores throughout the structure. The walls illustrated in FIG. 7(a) also contain high amounts of isolated pores and open-air pores with finer pores within the walls of large reservoir pores due to the exothermic reaction of nano-silicon with high specific surface area. As illustrated in FIG. 7(b), 1 weight % silicon powder with 14.4 μm average particle size resulted in decreased pores in the walls of the geopolymer due to less reaction with silicon power due to the decreased surface area of the coarser Si particles. The silicon powder still demonstrated open-air pores with finer pores inside walls of the open-air pores, but less reservoir area type pores than nano-silicon powder. FIG. 7(c) illustrates a SEM image of a geopolymer including silicon metal powder with 145 μm average particle size, in which open-air and interconnected pores were visible but finer pores were not. The large silicon particles had the least surface to react according to equation (1) so as to release H₂ gas. The geopolymer including 145 μm particle size silicon powder included almost no reservoir areas. Thus, the reactivity of silicon powder was improved by decreased particle size. Finer particles were more easily oxidized to form surface metastable oxide in open air and in alkaline environment.

### IV. Preparation of Graphene Oxide.

Graphene oxide (“GO”) was prepared from graphite flakes by Hummer's method. Black graphite powder (2.0 g) with an average particle size of 20 μm and sodium nitrate (NaNO₃, 2.0 g) were added to a 500-milliliter conical flask. Subsequently, 1 M sulfuric acid was added, and the mixture was mixed on a magnetic stirrer at 500 rpm, then cooled down to 0-5° C. in an ice-water bath. KMnO₄ (11.977 g) was added gradually in small doses, with the temperature controlled below 20° C. After adding the KMnO₄, the temperature of the solution was increased to 35° C. and the solution was mixed for 1 hour with the addition of 100 mL of deionized water. Then 300 mL of deionized water was added and the temperature was increased to 90° C. for 30 minutes, with dropwise addition of 3 vol % hydrogen peroxide (H₂O₂, 13.33 g). The resultant mixture was centrifuged at 8000 rpm for 5 minutes, then the separated supernatant was drained out, and the pH was measured, with subsequent cycles (approximately 30 cycles) of deionized water being added with centrifuging at 8000 rpm for 5 minutes, until the pH reached 7. The mixture suspension was taken into petri dishes to be dried in an oven at 98° C. to provide graphene oxide as a brownish powder.

### V. Addition of GO to Geopolymer Composition.

Metakaolin and waterglass mixture were shear mixed until evenly dispersed to provide a cement-like slurry. At the end of shear mixing, silicon powder was added to provide porosity, and graphene oxide was added to be captured in the pores as “flakes.” To produce the discrete pores and enhance the oxidation of Si, hydrogen peroxide was added to the mixture. The mixture was cast into a desired mold shape and left in the oven with closed lids and at 90% relative humidity for at least 24 hours. The temperature was varied at 30° C., 50° C., and 70° C. for the over curing of various samples. After 24 hours, the samples were taken out of the oven and left at room temperature within the molds, and the humidity was maintained. After 3 days, the samples were taken out of the molds and kept at room temperature for at least 7 days to reach a stable mass.

It was expected that the higher the curing temperature, the higher the specific surface area for similar particle sizes (approximately 45 microns). Generally, 50° C. curing temperature with 1 weight % Si, with up to 3 weight % graphene oxide was the best in the experiments for sequestration of chemical species due to the increased amount of graphene oxide in the open network pores of the geopolymer.

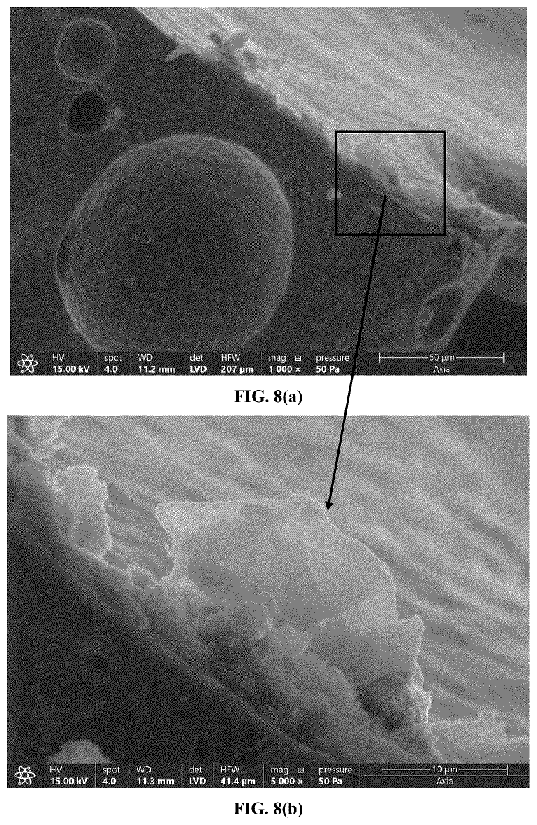

FIG. 8(b) illustrates examples of graphene oxide “flakes” as they were embedded into an example of a geopolymer structure from one end and are generally in the shape of a hexagon of c-axis. The joining of the graphene oxide to the structure is mechanical, not chemical, and is a result of the shrinkage of the body during the maturation and standing inside the structure. The pores are also bigger, such as at least 500 μm average particle size, and also present are pores of 50 μm and 10 μm average particle size.

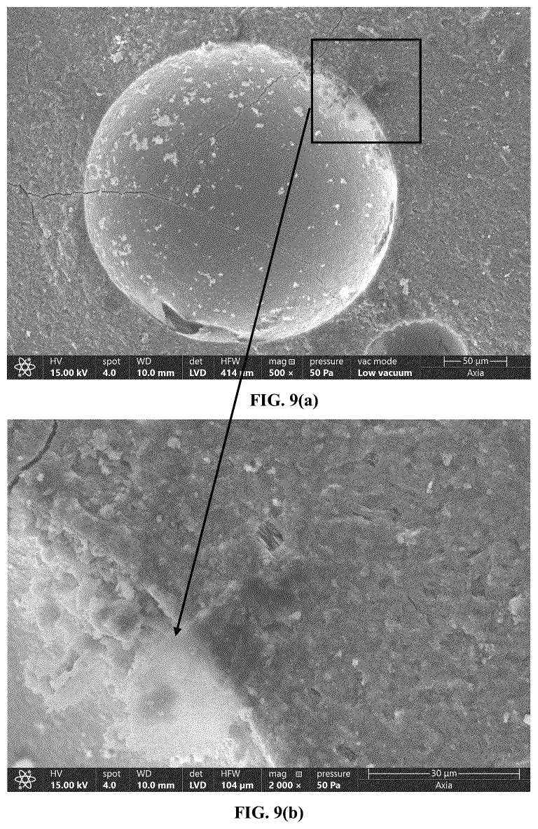

FIG. 9(b) illustrates another example of a graphene oxide “flake” around the fracture of a pore, embedded into an example of a geopolymer. The transparency of the graphene oxide suggests that the graphene oxide is only a few layers thick and may be only tens of nanometers thick.

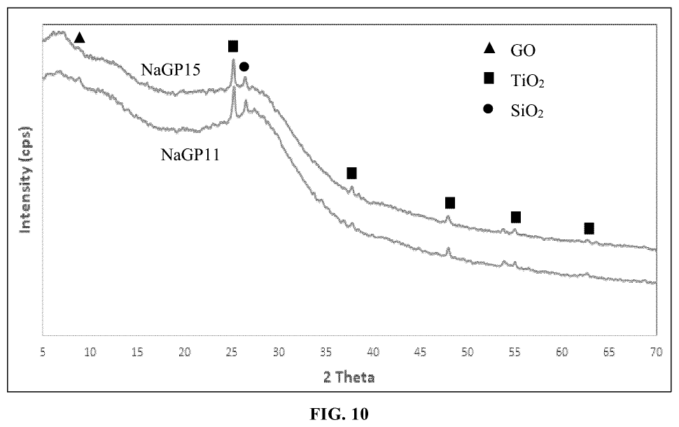

FIG. 10 illustrates XRD patterns of geopolymers including 1 weight % silicon, 1 weight % graphene oxide, and 1 weight % H₂O₂ solution applied. The hump between 25° and 30° C. is characteristic for geopolymer formation as it was shifted from 20° to 25°-30° 2θ.

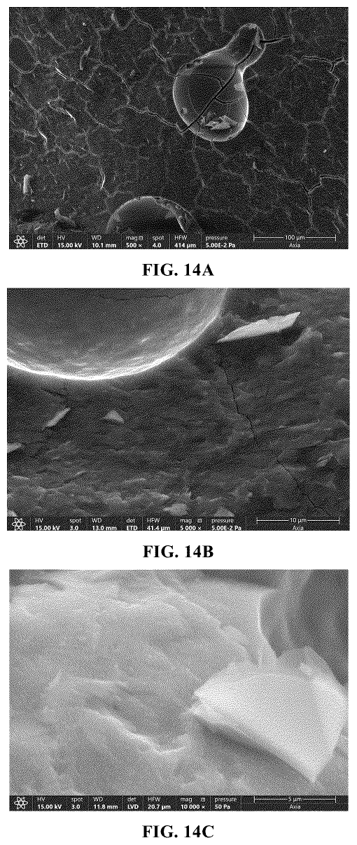

FIGS. 14A, 14B, and 14C illustrate SEM images of graphene oxide flakes decorating the pores of a geopolymer composition.

VI. Removal of Arsenic from Solution.

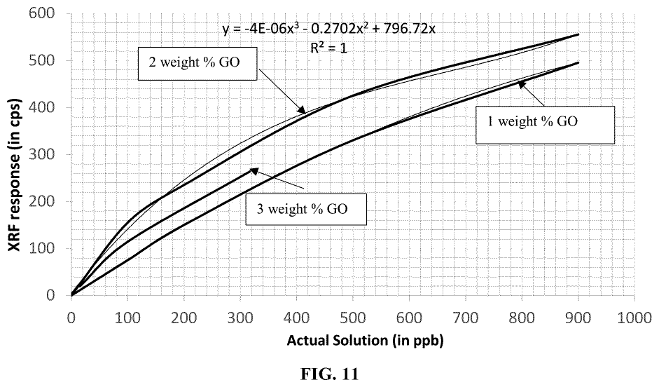

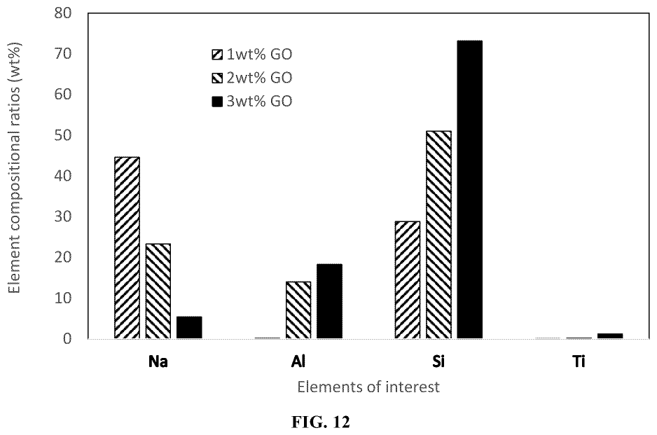

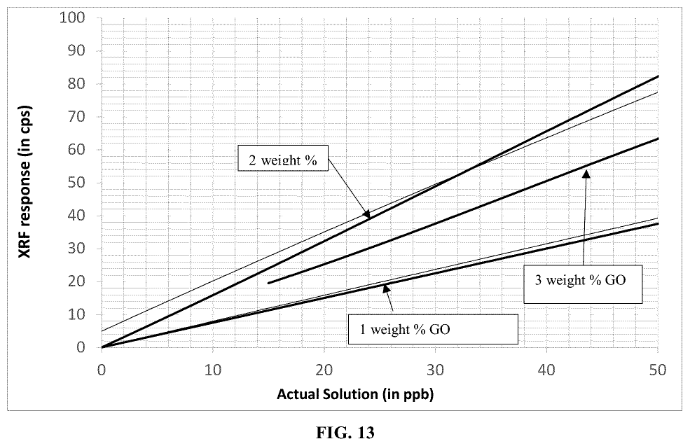

Using NaAsO₄ as an arsenic source, X-ray fluorescence (“XRF”) was used to determine the ability of geopolymer compositions of the present disclosure to remove arsenic from an aqueous solution. In a powder form, sufficient NaAsO₄ was added to water to provide a solution including 500 ppb of arsenic. Samples of geopolymer composition were immersed in the solution for 24 hours on a magnetic stirrer at room temperature. The solutions were subsequently centrifuged and filtered to separate any geopolymer composition from solution. The solutions were measured by XRF. FIG. 11 illustrated the upper and lower limits of XRF counts vs. actual solution parts per billion (“ppb”). FIG. 12 illustrated XRF results of elemental weight % ratios by different graphene oxide weight % in filtered solutions after arsenic was removed. Based on FIG. 12, by increasing the graphene oxide amount in the geopolymer in the compositions of the present disclosure, the sodium amount decreased in the filtered solution as sodium and arsenic were captured together in the geopolymer. Due to the sodium deficiency, aluminum and silicon could have been released to the filtered solution with an increased amount of graphene oxide. As a result of the XRF analysis, as illustrated in FIG. 13, the level of arsenic in the aqueous solution was reduced to 16 parts per billion by use of 3 weight % graphene oxide in geopolymer composition.

Geopolymer compositions of the present disclosure may be used to remove polyfluorinated or perfluorinated chemical species from aqueous solution. The polyfluorinated or perfluorinated chemical species may be subsequently chemically decomposed with ultraviolet radiation. The sequestration agents of the geopolymer compositions may be particulate graphite or graphene oxide from burnt waste wood. The sequestration agent may be attached to porous geopolymer acting as a support.

Although the present disclosure has been described with reference to examples and the accompanying drawings, the present disclosure is not limited thereto, but may be variously modified and altered by those skilled in the art to which the present disclosure pertains without departing from the spirit and scope of the present disclosure.

The subject-matter of the disclosure may also relate, among others, to the following aspects:

A first aspect relates to a water-filtering composition, comprising: a geopolymer; a foaming agent; and a sequestration agent.

A second aspect relates to the composition of aspect 1, wherein the sequestration agent comprises graphene nanoribbon, graphene oxide, reduced graphene oxide, iron oxide, titanium oxide, or combinations thereof.

A third aspect relates to the composition of aspect 1, wherein the foaming agent is silicon powder and hydrogen peroxide.

A fourth aspect relates to the composition of aspect 1, wherein the foaming agent is silicon powder and hydrogen peroxide.

A fifth aspect relates to the composition of aspects 1 to 4, wherein the geopolymer comprises pores having an average pore size of greater than about 500 μm.

A sixth aspect relates to the composition of aspects 1 to 4, wherein the geopolymer comprises pores having an average pore size of less than about 50 μm.

A seventh aspect relates to the composition of aspects 1 to 4, wherein the geopolymer comprises pores having an average pore size of greater than about 500 μm and pores having an average pore size of less than about 50 μm.

An eighth aspect relates to the composition of any preceding aspect, wherein the sequestration agent is present in an amount of from about 0.5 weight % to about 5.0 weight % based on a combined 100 weight % total of the composition.

A ninth aspect relates to a filter comprising the composition of any preceding aspect.

A tenth aspect relates to the filter of aspect 9, disposed in a water source.

An eleventh aspect relates to the filter of aspect 10, wherein the water source is natural, anthropogenic, or an industrial effluent.

A twelfth aspect relates to a chemical reactor comprising the filter of aspect 9 or the composition of aspects 1 to 8.

A thirteenth aspect relates to a water filtration system comprising the filter of aspect 9 submerged within a body of water.

A fourteenth aspect relates to the system of aspect 13, wherein the filter is disposed in the body of water to decrease an amount of a chemical species in the body of water.

A fifteenth aspect relates to the system of aspect 13, wherein the chemical species comprises a neutral or ionic heavy metal species.

A sixteenth aspect relates to the system of aspect 14 or 15, wherein the chemical species comprises arsenic, lead, zinc, nickel, copper, mercury, or combinations thereof.

A seventeenth aspect relates to the system of aspects 14 to 16, wherein the chemical species comprises arsenic.

An eighteenth aspect relates to the system of aspect 13, wherein the chemical species is polyfluorinated.

A nineteenth aspect relates to the system of aspect 18, wherein the chemical species is perfluorinated.

A twentieth aspect relates to the system of aspect 18 or 19, wherein the chemical species is perfluorooctanesulfonic acid (“PFOS”) or perfluorooctanoic acid (“PFOA”).

A twenty-first aspect relates to a process for preparing the composition of aspects 1 to 8, comprising: mixing metakaolin and waterglass to produce a mixture; adding an amount of the foaming agent to the mixture to produce a porous mixture; and adding the sequestration agent to the porous mixture to produce the composition.

A twenty-second aspect relates to the process of aspect 21, further comprising: heating the composition in at least 50% relative humidity.

A twenty-third aspect relates to the process of aspect 22, wherein the heating is for at least 24 hours.

A twenty-fourth aspect relates to the process of aspect 22 or 23, wherein the heating is at ≤90% relative humidity.

A twenty-fifth aspect relates to the process of aspects 22 to 24, wherein the heating is at a temperature of from about 40° C. to about 60° C.

A twenty-sixth aspect relates to the process of aspects 21 to 25, wherein the amount of the foaming agent is from about 0.5 weight % to about 4.0 weight % based on 100% total weight of the composition.

A twenty-seventh aspect relates to a method of reducing an amount of a chemical species in a body of water, comprising: adding to the body of water a filter comprising a composition, the composition comprising a geopolymer, a foaming agent, and a sequestration agent.

A twenty-eighth aspect relates to the method of aspect 27, wherein the amount of the chemical species is reduced to less than 20 parts per billion (“ppb”).

A twenty-ninth aspect relates to the method of aspect 27 or 28, wherein the chemical species comprises a neutral or ionic heavy metal species.

A thirtieth aspect relates to the method of aspect 29, wherein the heavy metal species comprises arsenic, lead, zinc, nickel, copper, mercury, or combinations thereof.

A thirty-first aspect relates to the method of aspect 27, wherein the chemical species is polyfluorinated.

A thirty-second aspect relates to the method of aspect 31, wherein the chemical species is perfluorinated.

A thirty-third aspect relates to the method of aspect 31 or 32, wherein the chemical species is perfluorooctanesulfonic acid (“PFOS”) or perfluorooctanoic acid (“PFOA”).

A thirty-fourth aspect relates to the method of aspects 27 to 33, wherein the amount of the chemical species is reduced by the filter more than a filter without the sequestration agent and/or without the foaming agent.

A thirty-fifth aspect relates to the method of aspects 27 to 34, wherein the sequestration agent comprises graphene nanoribbon, graphene oxide, reduced graphene oxide, iron oxide, titanium oxide, or combinations thereof.

A thirty-sixth aspect relates to the method of aspects 27 to 35, wherein the geopolymer comprises pores having an average pore size of greater than about 500 μm.

A thirty-seventh aspect relates to the method of aspects 27 to 35, wherein the geopolymer comprises pores having an average pore size of less than about 50 μm.

A thirty-eighth aspect relates to the method of aspects 27 to 35, wherein the geopolymer comprises pores having an average pore size of greater than about 500 μm and pores having an average pore size of less than about 50 μm.

A thirty-ninth aspect relates to the method of aspects 27 to 38, wherein the sequestration agent is present in an amount of from about 0.5 weight % to about 5.0 weight % based on a combined 100 weight % total of the composition.

In addition to the features mentioned in each of the independent aspects enumerated above, some examples may show, alone or in combination, the optional features mentioned in the dependent aspects and/or as disclosed in the description above and shown in the figures.

What is claimed is:

1. A water-filtering composition, comprising:
a geopolymer;
a foaming agent; and
a sequestration agent.

2. The composition of claim 1, wherein the sequestration agent comprises graphene nanoribbon, graphene oxide, reduced graphene oxide, iron oxide, titanium oxide, or combinations thereof.

3. The composition of claim 1, wherein the foaming agent is silicon powder.

4. The composition of claim 1, wherein the foaming agent is silicon powder and hydrogen peroxide.

5. The composition of claim 1, wherein the geopolymer comprises pores having an average pore size of greater than about 500 μm and/or pores having an average pore size of less than about 50 μm.

6. The composition of claim 1, wherein the sequestration agent is present in an amount of from about 0.5 weight % to about 5.0 weight % based on a combined 100 weight % total of the composition.

7. A filter comprising the composition of claim 1.

8. The filter of claim 7, disposed in a water source.

9. A water filtration system comprising the filter of claim 7 submerged within a body of water.

10. The system of claim 9, wherein the filter is disposed in the body of water to decrease an amount of a chemical species in the body of water.

11. The system of claim 10, wherein the chemical species comprises a neutral or ionic heavy metal species.

12. The system of claim 10, wherein the chemical species comprises arsenic, lead, zinc, nickel, copper, mercury, or combinations thereof.

13. The system of claim 10, wherein the chemical species is polyfluorinated.

14. A process for preparing the composition of claim 1, comprising:
mixing metakaolin and waterglass to produce a mixture;
adding an amount of the foaming agent to the mixture to produce a porous mixture; and
adding the sequestration agent to the porous mixture to produce the composition.

15. The process of claim 14, further comprising:
heating the composition in at least 50% relative humidity.

16. The process of claim 14, wherein the amount of the foaming agent is from about 0.5 weight % to about 4.0 weight % based on 100% total weight of the composition.

17. A method of reducing an amount of a chemical species in a body of water, comprising:
adding to the body of water a filter comprising a composition, the composition comprising a geopolymer, a foaming agent, and a sequestration agent.

18. The method of claim 17, wherein the amount of the chemical species is reduced to less than 20 parts per billion (“ppb”).

19. The method of claim 17, wherein the chemical species comprises a neutral or ionic heavy metal species.

20. The method of claim 17, wherein the chemical species is polyfluorinated.

21. The method of claim 17, wherein the amount of the chemical species is reduced by the filter more than a filter without the sequestration agent and/or without the foaming agent.
